(19) United States
(12) Patent Application Publication
(10) Pub. No.: US 2024/0328476 A1
(43) Pub. Date: Oct. 3, 2024

(54) CYLINDRICAL VIBRATION ISOLATOR AND INTERMEDIATE SLEEVE

(71) Applicant: Sumitomo Riko Company Limited, Aichi (JP)

(72) Inventors: Takashi KUME, Aichi (JP); Masanobu Mizusaki, Aichi (JP); Yuya Horibe, Aichi (JP); Shunsuke Ota, Aichi (JP)

(73) Assignee: Sumitomo Riko Company Limited, Aichi (JP)

(21) Appl. No.: 18/735,192

(22) Filed: Jun. 6, 2024

Related U.S. Application Data
(63) Continuation of application No. PCT/JP2023/032640, filed on Sep. 7, 2023.

(30) Foreign Application Priority Data
Sep. 28, 2022 (JP) 2022-155048

(51) Int. Cl. F16F 1/387

(52) U.S. Cl. CPC F16F 1/3876

(57) ABSTRACT

Provided are a cylindrical vibration isolator and an intermediate sleeve. In the cylindrical vibration isolator, an inner shaft member and an outer cylindrical member are connected by a main body rubber elastic body, and a cylindrical intermediate sleeve extending in a circumferential direction between the inner shaft member and the outer cylindrical member in a radial direction is fixed to the main body rubber elastic body. A slit penetrating axially is formed in a part of the intermediate sleeve in the circumferential direction. Both end parts of the slit are straight parts extending axially. A direct overlap margin of the straight parts on both sides in axial view is smaller than a radial thickness of the intermediate sleeve.

### CROSS-REFERENCE TO RELATED APPLICATION

This application is a continuation of PCT International Application No. PCT/JP2023/032640, filed on Sep. 7, 2023, which claims priority under 35 U.S.C § 119 (a) to Japanese Patent Application No. 2022-155048, filed on Sep. 28, 2022. Each of the above application(s) is hereby expressly incorporated by reference, in its entirety, into the present application.

### BACKGROUND

### Technical Field

The disclosure relates to a cylindrical vibration isolator applied to engine mounts, suspension bushes, etc. of automobiles, and an intermediate sleeve for the cylindrical vibration isolator.

### Related Art

Conventionally, cylindrical vibration isolators applied to engine mounts and suspension bushes of automobiles have been known. For example, a cylindrical vibration isolator has a structure in which an inner shaft member (inner cylinder) and an outer cylindrical member (outer cylinder) are connected by a main body rubber elastic body (rubber-like elastic body), as a bush disclosed in Utility Model Application Publication No. H2-034839 (Patent Literature 1).

Further, in the cylindrical vibration isolator, a cylindrical intermediate sleeve may be employed, for example, for the purpose of achieving both low dynamic spring properties in the torsional direction and high dynamic spring properties in the direction perpendicular to an axis. The intermediate sleeve is arranged to extend in a circumferential direction between the inner shaft member and the outer cylindrical member in a radial direction, and is connected to the inner shaft member and the outer cylindrical member by the main body rubber elastic body.

### CITATION LIST

### Patent Literature

[Patent Literature 1] Utility Model Application Publication No. H2-034839

An intermediate sleeve may have a continuous cylindrical shape across the entire circumference, but, for example, Patent Literature 1 discloses an intermediate sleeve (intermediate cylinder) in which a part in the circumferential direction is divided by a slit. Accordingly, when reducing the diameter of the outer cylindrical member, a slit width becomes narrower, allowing for diameter reduction deformation of the intermediate sleeve, such that pre-compression may be applied not only to the rubber between the outer cylindrical member and the intermediate sleeve in a radial direction, but also to the rubber between the intermediate sleeve and the inner shaft member in the radial direction.

However, if a slit is formed in the intermediate sleeve to form a C-shaped cylinder as in Patent Literature 1, for example, when applying blast treatment to a large number of intermediate sleeves at once (roughening the surface by spraying blast material) as a pretreatment for vulcanization-bonding of the main body rubber elastic body, the other intermediate sleeve may enter the slit in a drum of the blast treatment equipment. A new problem has been revealed in that if the other intermediate sleeve enters the slit, an overlapped part of the intermediate sleeves may not be sufficiently treated.

An object of the disclosure is to provide a cylindrical vibration isolator with a novel structure that can achieve stable quality by effectively applying blast treatment or the like to the entire intermediate sleeve.

Another object of the disclosure is to provide an intermediate sleeve for a cylindrical vibration isolator having a novel structure in which it is difficult for the other intermediate sleeve to enter the slit.

### SUMMARY OF DISCLOSURE

A first aspect is a cylindrical vibration isolator, in which an inner shaft member and an outer cylindrical member are connected by a main body rubber elastic body, and a cylindrical intermediate sleeve that extends in a circumferential direction between the inner shaft member and the outer cylindrical member in a radial direction is fixed to the main body rubber elastic body. A slit penetrating axially is formed in a part of the circumferential direction in the intermediate sleeve, both end parts of the slit are straight parts extending axially, and a direct overlap margin of the straight parts on both sides in axial view is smaller than a radial thickness of the intermediate sleeve.

A fourth aspect is an intermediate sleeve for cylindrical vibration isolator, which includes a cylindrical part extending in a circumferential direction between an inner shaft member and an outer cylindrical member in a radial direction, the cylindrical part being connected to the inner shaft member and the outer cylindrical member by a main body rubber elastic body. A slit penetrating axially is formed in a part of the circumferential direction in the cylindrical part, both end parts of the slit are straight parts extending axially, and a direct overlap margin of the straight parts on both sides in axial view is smaller than a radial thickness of the cylindrical part.

### BRIEF DESCRIPTION OF DRAWINGS

FIG. 1 is a front view of a cylindrical vibration isolator as a first embodiment of the disclosure.

FIG. 2 is a cross-sectional view of II-II in FIG. 1.

FIG. 3 is a cross-sectional view of III-III in FIG. 1.

FIG. 4 is a cross-sectional view of IV-IV in FIG. 2.

FIG. 5 is a cross-sectional view of V-V in FIG. 2.

FIG. 6 is a front view showing the cylindrical vibration isolator shown in FIG. 1 in a state before diameter reduction processing.

FIG. 7 is a cross-sectional view of VII-VII in FIG. 6.

FIG. 8 is a cross-sectional view of VIII-VIII in FIG. 7.

FIG. 9 is a cross-sectional view of IX-IX in FIG. 7.

FIG. 10A is a plan view of an intermediate sleeve constituting the cylindrical vibration isolator shown in FIG. 6.

FIG. 10B is a plan view of an intermediate sleeve constituting the cylindrical vibration isolator shown in FIG. 1.

FIG. 11 is a front view showing a cylindrical vibration isolator as a second embodiment of the disclosure in a state before diameter reduction processing.

FIG. 12 is a cross-sectional view taken along line XII-XII in FIG. 11.

FIG. 13 is a cross-sectional view taken along line XIII-XIII in FIG. 12.

FIG. 14A is a plan view of an intermediate sleeve constituting the cylindrical vibration isolator shown in FIG. 11.

FIG. 14B is a plan view showing the intermediate sleeve shown in FIG. 14A in a state after diameter reduction processing.

FIG. 15 is a front view showing a cylindrical vibration isolator as a third embodiment of the disclosure in a state before diameter reduction processing.

FIG. 16 is a cross-sectional view taken along line XVI-XVI in FIG. 15.

FIG. 17 is a cross-sectional view of XVII-XVII in FIG. 16.

FIG. 18A is a plan view of an intermediate sleeve constituting the cylindrical vibration isolator shown in FIG. 15.

FIG. 18B is a plan view showing the intermediate sleeve shown in FIG. 18A in a state after diameter reduction processing.

FIG. 19A is a plan view showing an intermediate sleeve constituting a cylindrical vibration isolator as a fourth embodiment of the disclosure in a state before diameter reduction processing.

FIG. 19B is a plan view showing the intermediate sleeve shown in FIG. 19A in a state after diameter reduction processing.

### DESCRIPTION OF EMBODIMENTS

Preferred aspects for understanding the disclosure will be described below. However, each aspect described below is exemplary; not only can it be employed in combination with each other as appropriate, but also the multiple components described in each aspect can be recognized and employed as independently as possible, and be employed in combination with any component described in another aspect as appropriate. Accordingly, the disclosure is not limited to the aspects described below, and various other aspects can be implemented.

A first aspect is a cylindrical vibration isolator, in which an inner shaft member and an outer cylindrical member are connected by a main body rubber elastic body, and a cylindrical intermediate sleeve that extends in a circumferential direction between the inner shaft member and the outer cylindrical member in a radial direction is fixed to the main body rubber elastic body. A slit penetrating axially is formed in a part of the circumferential direction in the intermediate sleeve, both end parts of the slit are straight parts extending axially, and a direct overlap margin of the straight parts on both sides in axial view is smaller than a radial thickness of the intermediate sleeve.

When the diameter of the outer cylindrical member is reduced to apply radial pre-compression to the main body rubber elastic body, the intermediate sleeve is reduced in diameter by being deformed such that a slit width becomes narrower, so the part of the main body rubber elastic body on the inner circumferential side of the intermediate sleeve is also effectively pre-compressed in the radial direction.

For example, when blast treatment or the like is applied to a large number of intermediate sleeves at the same time, there may be cases where the large number of intermediate sleeves are accommodated in a drum of processing equipment, and the processing is performed while the drum is being moved. At this time, according to the cylindrical vibration isolator having the structure according to this aspect, the straight parts constituting both axial end parts of the slit have a direct overlap margin in axial view smaller than a radial thickness of the intermediate sleeve. Thus, the other intermediate sleeve is suppressed from entering the slit of the intermediate sleeve over both straight parts, and the other intermediate sleeve is easily removed from the slit. Thus, it is possible to prevent the blast treatment from becoming partially insufficient due to the entering of the intermediate sleeve into the slit, and stably obtain a cylindrical vibration isolator having the desired quality. Moreover, even if the other intermediate sleeve is held in the state of entering to the slit of the intermediate sleeve and does not come off, the other intermediate sleeve does not enter over the straight parts on both sides of the slit, and the area not covered by the blast treatment or the like due to the entering of the other intermediate sleeve into the slit is decreased.

A second aspect is that, in the cylindrical vibration isolator described in the first aspect, the straight parts on both sides of the slit are formed at different positions in the circumferential direction of the intermediate sleeve, and the slit includes an intermediate part that mutually connects the straight parts on both sides in the circumferential direction.

According to the cylindrical vibration isolator having the structure according to this aspect, since the straight parts on both sides are formed at different positions in the circumferential direction of the intermediate sleeve, and the slit is formed by connecting the straight parts by the intermediate part, while effectively allowing the intermediate sleeve to be reduced in diameter by forming the slit, it is possible to effectively prevent the other intermediate sleeve from entering the slit over the straight parts on both sides.

A third aspect is that, in the cylindrical vibration isolator described in the second aspect, an intermediate rubber that mutually connects both axial side parts of the intermediate sleeve with respect to the intermediate part is provided in the intermediate part of the slit.

According to the cylindrical vibration isolator having the structure according to this aspect, the intermediate part extending in the circumferential direction midway in the axial direction of the intermediate sleeve is formed with the intermediate rubber during molding of the main body rubber elastic body, but since the intermediate rubber is shear-deformed when the intermediate sleeve is reduced in diameter, the spring constant is suppressed compared to the case of compression deformation, and the diameter reduction deformation of the intermediate sleeve is less likely to be interfered. Thus, while effectively implementing pre-compression of the main body rubber elastic body by the diameter reduction deformation of the intermediate sleeve, by forming an intermediate part extending in the circumferential direction and significantly shifting the circumferential position of the straight parts on both sides, it is possible to prevent the other intermediate sleeve extending to the straight parts on both sides from entering the slit.

A fourth aspect is an intermediate sleeve for cylindrical vibration isolator, which includes a cylindrical part extending in a circumferential direction between an inner shaft member and an outer cylindrical member in a radial direction, the cylindrical part being connected to the inner shaft member and the outer cylindrical member by a main body rubber elastic body. A slit penetrating axially is formed in a part of the circumferential direction in the cylindrical part, both end parts of the slit are straight parts extending axially, and a direct overlap margin of the straight parts on both sides in axial view is smaller than a radial thickness of the cylindrical part.

According to the intermediate sleeve for a cylindrical vibration isolator having the structure according to this aspect, it is possible to prevent the cylindrical part of the other intermediate sleeve from entering the slit over the straight parts on both axial sides, the other intermediate sleeve that has entered the slit of the intermediate sleeve becomes easily to come off from the slit.

Moreover, in the fourth aspect, a configuration may be adopted in which the straight parts on both sides of the slit are formed at different positions in the circumferential direction of the cylindrical part, and the slit includes an intermediate part that mutually connects the straight parts on both sides in the circumferential direction. As a result, the same effect as in the second aspect can be obtained.

According to the disclosure, in the cylindrical vibration isolator, by suppressing the other intermediate sleeve from entering the slit, blast treatment or the like to the intermediate sleeve can be effectively applied to the entire intermediate sleeve so as to achieve stable quality.

Moreover, in the intermediate sleeve for cylindrical vibration isolator, it is possible to suppress the cylindrical part of the other intermediate sleeve from entering into the slit of the cylindrical part.

Embodiments of the disclosure will be described below with reference to the drawings.

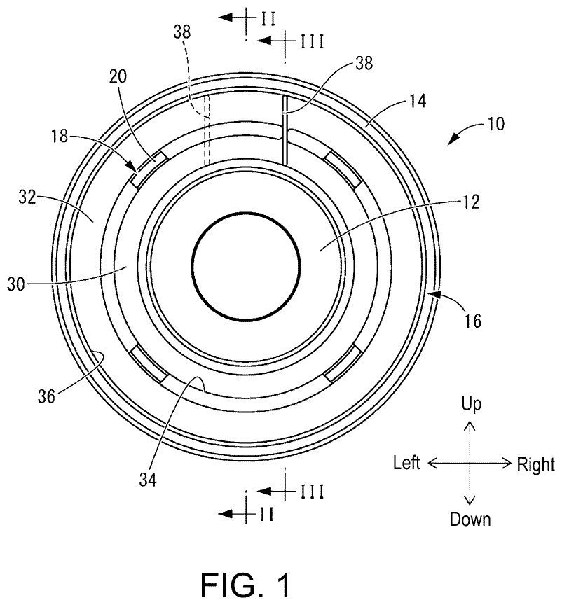

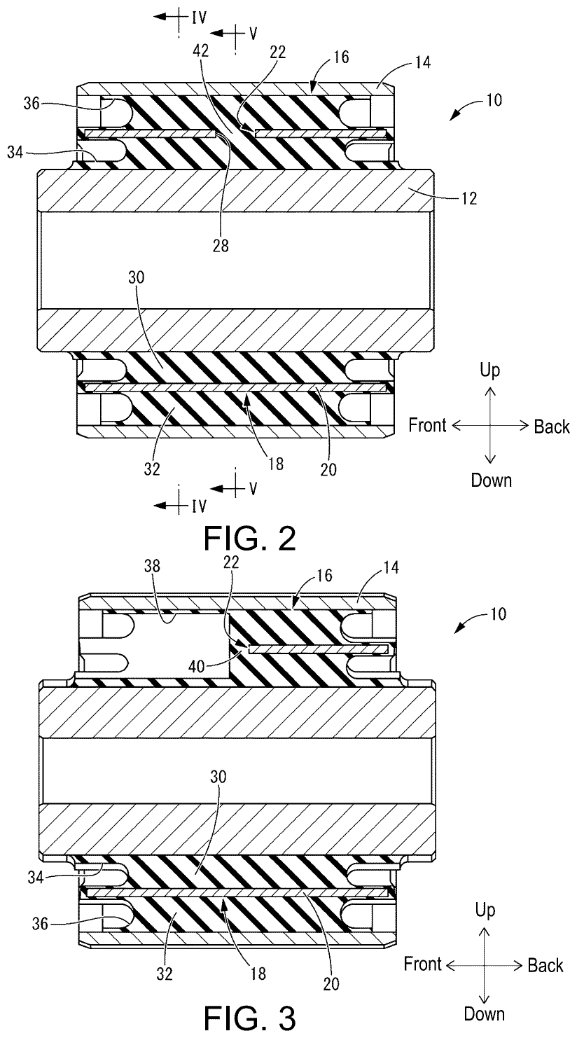

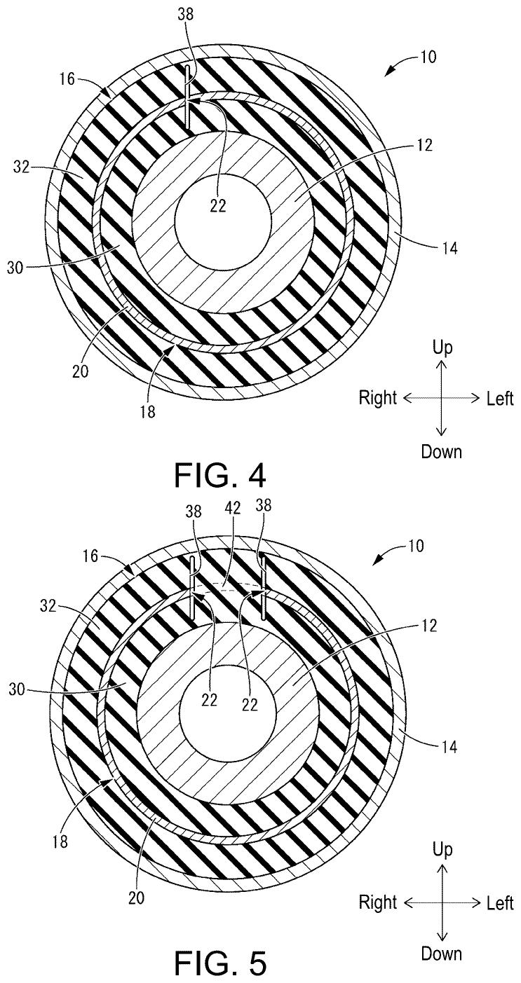

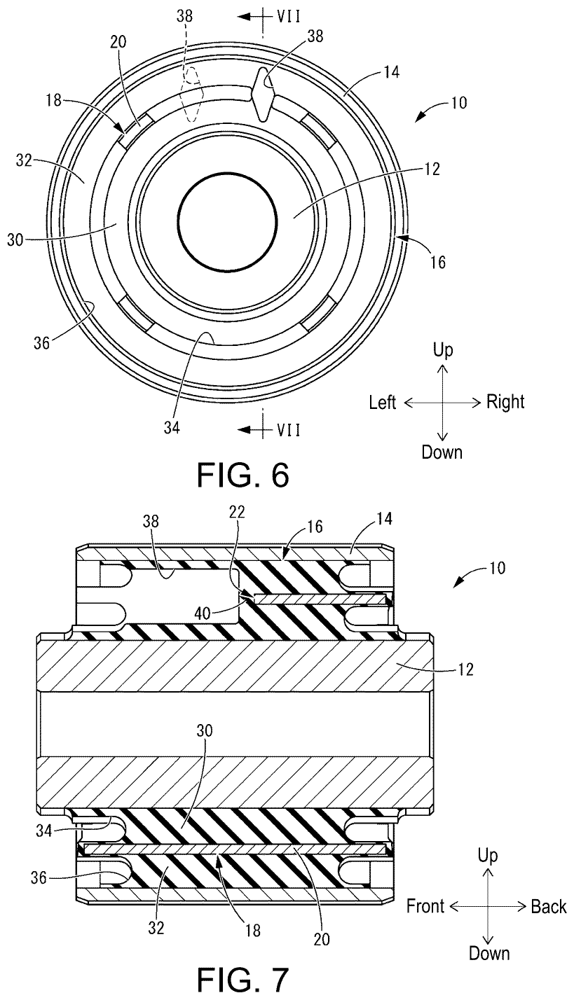

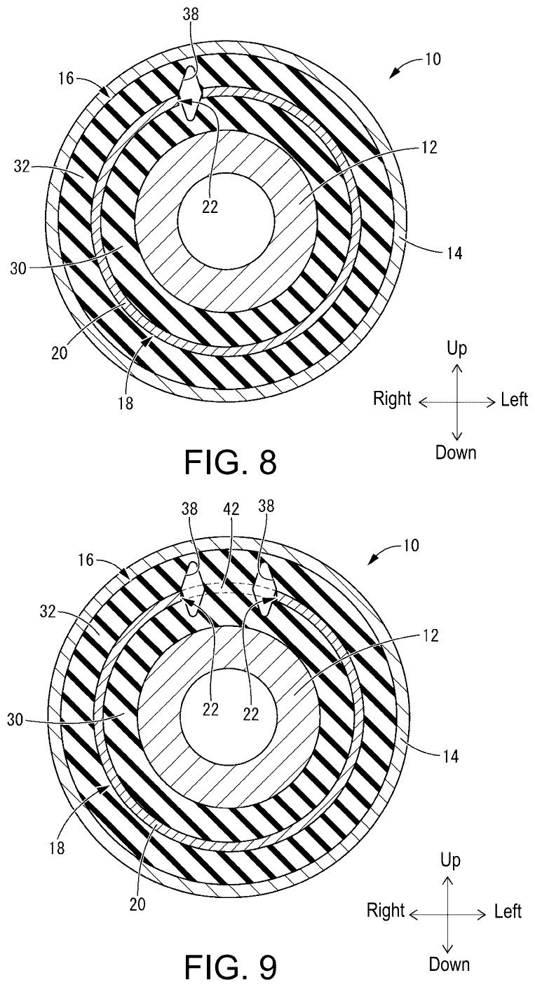

FIGS. 1 to 5 show a cylindrical vibration isolator 10 as a first embodiment of the disclosure. The cylindrical vibration isolator 10 has a structure in which an inner shaft member 12 and an outer cylindrical member 14 are connected by a main body rubber elastic body 16. In the following description, as a general rule, the up-down direction refers to the up-down direction in FIG. 1, the left-right direction refers to the left-right direction in FIG. 1, and the front-back direction refers to the left-right direction in FIG. 2. Moreover, FIGS. 6 to 9 show a state before the diameter reduction processing is performed on the outer cylindrical member 14 of the cylindrical vibration isolator 10 (integrally vulcanization-molded product of the main body rubber elastic body 16). In the following, each member and part of the cylindrical vibration isolator 10 before the diameter reduction processing will be described, and then the deformation of the outer cylindrical member 14 due to the diameter reduction processing will be described.

The inner shaft member 12 is a hard member made of metal or synthetic resin, and has a substantially cylindrical shape with a thick wall and a small diameter. The inner shaft member 12 has a symmetrical shape in which the axial direction is not limited.

The outer cylindrical member 14 is a hard member made of metal or synthetic resin, and has a substantially cylindrical shape with a thinner wall and larger diameter than the inner shaft member 12. The outer cylindrical member 14 has a shorter axial length than the inner shaft member 12. The outer cylindrical member 14 has a symmetrical shape in which the axial direction is not limited. Outer circumferential surfaces of the outer cylindrical member 14 at both axial end parts have a tapered shape that becomes smaller in diameter toward the outer side in the axial direction.

As shown in FIGS. 6 to 9, the inner shaft member 12 is inserted into the outer cylindrical member 14, and a cylindrical intermediate sleeve 18 is disposed between the inner shaft member 12 and the outer cylindrical member 14 in the radial direction. The intermediate sleeve 18 is a hard member made of metal or synthetic resin, and includes a cylindrical part 20 that has a substantially cylindrical shape as a whole. The cylindrical part 20 of the intermediate sleeve 18 of the embodiment is thinner than the outer cylindrical member 14. The cylindrical part 20 has a smaller axial dimension than the outer cylindrical member 14. The cylindrical part 20 has a larger diameter than the inner shaft member 12 and a smaller diameter than the outer cylindrical member 14, and extends in the circumferential direction between the inner shaft member 12 and the outer cylindrical member 14 in the radial direction. The cylindrical part 20 is spaced apart toward the outer circumference from the outer circumferential surface of the inner shaft member 12 and spaced apart toward the inner circumference from the inner circumferential surface of the outer cylindrical member 14.

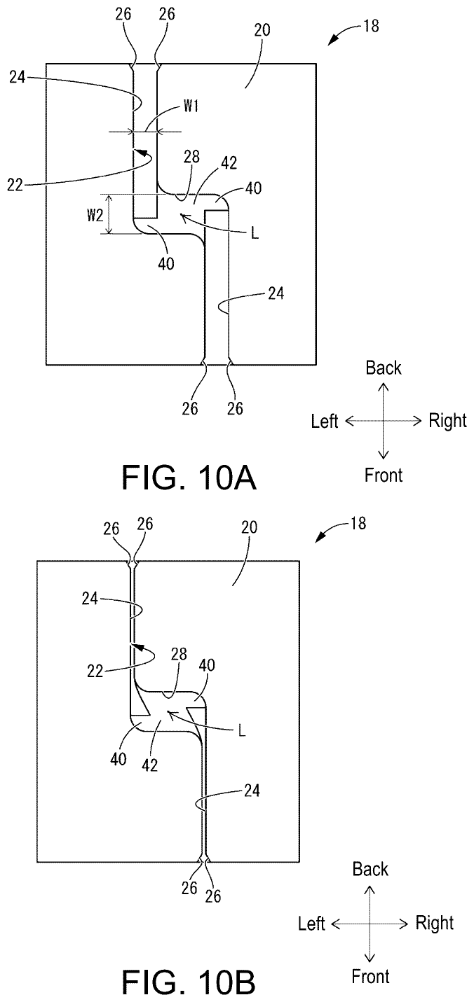

As shown in FIG. 10A, the cylindrical part 20 of the intermediate sleeve 18 is formed with a slit 22 penetrating as a whole axially. The slit 22 is provided in a part of the intermediate sleeve 18 in the circumferential direction, and the intermediate sleeve 18 is form in a substantially C-like cylinder shape divided into parts in the circumferential direction by the slit 22.

Both end parts of the slit 22 are straight parts 24, 24 extending axially. The straight part 24 of the embodiment extends linearly. The straight part 24 extends axially with a substantially constant width, but may be set with a draft taper, for example, to facilitate removal of a mold inserted during molding of the main body rubber elastic body 16, which will be described below. Further, an expanded guide surface 26 is formed at the axial end of the straight part 24 and is inclined outward axially to both circumferential sides.

The straight parts 24, 24 on both axial sides are formed at different positions in the circumferential direction of the intermediate sleeve 18, and in the embodiment, are formed in positions separated from each other in the circumferential direction of the intermediate sleeve 18. In short, the straight parts 24, 24 of the embodiment do not overlap each other in axial view, and the overlap margin of the straight parts 24, 24 in axial view is made smaller than 0. Thus, the overlap margin of the straight parts 24, 24 is made smaller than a radial thickness of the cylindrical part 20 of the intermediate sleeve 18.

The straight parts 24, 24 are mutually connected by an intermediate part 28. The intermediate part 28 extends in the circumferential direction of the intermediate sleeve 18, and has one circumferential end connected to the straight part 24 on the front side, and the other circumferential end connected to the straight part 24 on the back side. A width w2 of the slit 22 in the intermediate part 28 may be smaller than a width w1 of the slit 22 in the straight parts 24, 24, but in the embodiment w2>w1. The width w1 of the slit 22 in the straight parts 24, 24 is the width of the straight part 24 in the intermediate sleeve 18 before diameter reduction, and is set according to the amount of diameter reduction deformation of the intermediate sleeve 18, which will be described later. In the intermediate sleeve 18 of the embodiment, the straight parts 24, 24 on both axial sides are rotationally symmetrical at 180 degree with respect to a symmetric shaft L which extends through a center of the slit 22 in a direction perpendicular to the axis (orthogonal to the paper surface in FIG. 10A), and the axial direction is not limited.

As shown in FIGS. 6 to 9, the main body rubber elastic body 16 is formed between the inner shaft member 12 and the outer cylindrical member 14 in the radial direction where the intermediate sleeve 18 is disposed. The main body rubber elastic body 16 is formed in a thick-walled substantially cylindrical shape, with its inner circumferential surface vulcanization-bonded to the outer circumferential surface of the inner shaft member 12, and its outer circumferential surface vulcanization-bonded to the inner circumferential surface of the outer cylindrical member 14. Further, the intermediate sleeve 18 is vulcanization-bonded to the radial middle of the main body rubber elastic body 16, and the main body rubber elastic body 16 is divided into an inner circumferential side and an outer circumferential side of the intermediate sleeve 18. Thereby, the main body rubber elastic body 16 is composed of an inner circumferential rubber 30 connecting the inner shaft member 12 and the cylindrical part 20 of the intermediate sleeve 18, and an outer circumferential rubber 32 connecting the cylindrical part 20 of the intermediate sleeve 18 and the outer cylindrical member 14. Almost the entire surface of the intermediate sleeve 18 is covered by the main body rubber elastic body 16, and the axial end of the cylindrical part 20 is partially exposed from the main body rubber elastic body 16 at multiple locations in the circumferential direction.

At both axial end parts of the inner circumferential rubber 30, an inner circumferential groove 34 is formed which extends continuously in the circumferential direction while opening outward axially. Further, at both axial end parts of the outer circumferential rubber 32, an outer circumferential groove 36 is formed which extends in the circumferential direction while opening outward axially. The inner circumferential groove 34 and the outer circumferential groove 36 of the embodiment both have axially inner bottom surfaces that are concave surfaces having a substantially semicircular arc shape. The axial end of the cylindrical part 20 of the intermediate sleeve 18 extends radially to between the inner circumferential groove 34 and the outer circumferential groove 36. Further, in the embodiment, the axial depth dimension of the inner circumferential groove 34 is made slightly smaller than the outer circumferential groove 36, but the depth dimensions of the inner circumferential groove 34 and the outer circumferential groove 36 may be the same, and the outer circumferential groove 36 may be smaller.

The main body rubber elastic body 16 has cavities 38, 38 formed in parts corresponding to the straight parts 24, 24 of the slit 22 of the intermediate sleeve 18. The cavity 38 opens in the axial end surface of the main body rubber elastic body 16 and extends linearly in the axial direction. The cavity 38 of the embodiment has a substantially rhombic cross-sectional shape in a state before the outer cylindrical member 14 is reduced in diameter, and is formed into a flat rhombic cross-sectional shape with a diagonal in the up-down direction longer than a diagonal in the left-right direction. A part of the cavity 38 is located within the straight part 24 of the slit 22 and extends to the inner circumferential side and the outer circumferential side more than the cylindrical part 20 of the intermediate sleeve 18. The cavity 38 corresponding to the straight part 24 on one axial side (front side) opens at an end surface in one axial direction of the main body rubber elastic body 16 and extends to midway in the axial direction of the main body rubber elastic body 16, and the cavity 38 corresponding to the straight part 24 on the other axial side (back side) opens at an end surface in the other axial direction of the main body rubber elastic body 16 and extends to midway in the axial direction of the main body rubber elastic body 16. Moreover, the cavity 38 in the embodiment does not reach the axially deep end of the straight part 24 (the end on the intermediate part 28 side), and a deep wall rubber 40 is provided at a deep side of the cavity 38.

The main body rubber elastic body 16 includes an intermediate rubber 42 that fills the intermediate part 28 of the slit 22 of the intermediate sleeve 18. As shown in FIG. 10A, the intermediate rubber 42 extends axially in the intermediate part 28, both axial end parts thereof fixed to the intermediate sleeve 18, and axially connects both axial side parts of the intermediate sleeve 18 sandwiching the intermediate part 28. As shown in FIG. 9, the cavities 38, 38 are located on both circumferential sides of the intermediate rubber 42, respectively. The intermediate rubber 42 is formed integrally and continuously with the inner circumferential rubber 30 and the outer circumferential rubber 32 in the radial direction, and the inner circumferential rubber 30 and the outer circumferential rubber 32 are integrally connected to each other by the intermediate rubber 42. Moreover, when the main body rubber elastic body 16 is molded, it is difficult to insert a mold into the intermediate part 28 extending in the circumferential direction, and it is difficult to form a space in the intermediate part 28 like the cavities 38, 38 of the straight parts 24, 24, so the intermediate rubber 42 is formed to fill the intermediate part 28.

By performing diameter reduction processing (drawing processing) on the outer cylindrical member 14 after vulcanization-molding of the main body rubber elastic body 16, the cylindrical vibration isolator 10 shown in FIGS. 1 to 5 is formed. In the cylindrical vibration isolator 10, through the diameter reduction processing of the outer cylindrical member 14, a radial pre-compression is applied the main body rubber elastic body 16 disposed between the inner shaft member 12 and the outer cylindrical member 14, and durability of the main body rubber elastic body 16 is improved because tensile stress caused by heat shrinkage or the like after molding of the main body rubber elastic body 16 is decreased. The method of reducing the diameter of the outer cylindrical member 14 is not particularly limited, but a diameter reduction method such as an eight-way drawing method may be adopted in which the outer cylindrical member 14 is pressed to the inner circumferential side by a jig that is pressed against the outer circumferential surface of the outer cylindrical member 14 in eight radial directions to reduce its diameter.

When the outer cylindrical member 14 is deformed and reduced in diameter, the outer circumferential rubber 32 disposed between the outer cylindrical member 14 and the intermediate sleeve 18 is compressed in the radial direction, and the durability of the outer circumferential rubber 32 is improved. Further, as the elasticity (reactive force against compression) of the outer circumferential rubber 32 is applied to the cylindrical part 20 of the intermediate sleeve 18, a force in the diameter reduction direction is also applied to the cylindrical part 20. With a part of the circumferential direction divided by the slit 22, the cylindrical part 20 deforms in response to an input in the diameter reduction direction such that the width of the straight parts 24, 24 at the slit 22 becomes narrower, as shown in FIG. 10b. As a result, by reducing the diameter of the outer cylindrical member 14, the cylindrical part 20 of the intermediate sleeve 18 is also deformed and reduced in diameter, and the inner circumferential rubber 30 disposed between the intermediate sleeve 18 and the inner shaft member 12 is also compressed in the radial direction, thereby improving the durability of the inner circumferential rubber 30. In this way, by forming the slit 22 in the intermediate sleeve 18, both the outer circumferential rubber 32 and the inner circumferential rubber 30 of the main body rubber elastic body 16 are pre-compressed, and durability is advantageously improved.

By reducing the diameter of the intermediate sleeve 18, as shown in FIGS. 1, 4, and 5, the cavities 38, 38 formed at the parts corresponding to the straight parts 24, 24 are deformed such that the circumferential width decreases. By forming the cavities 38, 38 in the straight parts 24, 24, respectively, the force required for diameter reduction deformation of the intermediate sleeve 18 is made smaller than a case where the straight parts 24, 24 are filled with rubber. If the straight parts 24, 24 are filled with rubber, a compression spring of the rubber will act as a resistance force against the diameter reduction of the intermediate sleeve 18, and a larger force will be required. In the embodiment, even after the diameter of the intermediate sleeve 18 is reduced, the narrowed cavities 38, 38 remain open on the axial end surface, for example, the inner surfaces of the walls on both circumferential sides of each cavity 38 may be brought into close contact with each other, such that the cavities 38, 38 substantially disappear.

Further, when the intermediate sleeve 18 is deformed and reduced in diameter, the intermediate rubber 42 formed in the intermediate part 28 of the slit 22 is shear-deformed with both axial end parts being relatively displaced in the circumferential direction. In this way, since a shear spring of the intermediate rubber 42, whose spring constant is smaller than the compression spring, acts as a resistance force against the diameter reduction of the intermediate sleeve 18, it is possible to reduce the diameter of the intermediate sleeve 18 with a smaller force than a case where the compression spring of the intermediate rubber 42 acts as a resistance force. Moreover, in the embodiment, the deep wall rubber 40 integrally formed with the main body rubber elastic body 16 is provided on axial deep sides of the cavities 38, 38, respectively. The deep wall rubber 40 is integrally continuous with the intermediate rubber 42, extending from the intermediate rubber 42 to a circumferential outer side and reaching the inner surface of a side wall of the straight part 24. However, one deep wall rubber 40 and the other deep wall rubber 40 are disposed at positions separated from each other in the axial direction, such that when the intermediate sleeve 18 is reduced in diameter, the intermediate rubber 42 is not subjected to pure compression in the circumferential direction, but a small resistance force by the shear spring of the intermediate rubber 42 acts.

In the cylindrical vibration isolator 10, the intermediate sleeve 18 extending in the circumferential direction is disposed between the inner shaft member 12 and the outer cylindrical member 14, such that a ratio of a spring in the direction perpendicular to the axis to the torsion in the circumferential direction (torsional direction) may be set to be larger. That is, by including the intermediate sleeve 18, the cylindrical vibration isolator 10 can easily achieve both a high dynamic spring in the direction perpendicular to the axis and a low dynamic spring in the torsional direction.

Before the main body rubber elastic body 16 is molded, blast treatment is applied to the intermediate sleeve 18 as a pretreatment to improve the adhesion of the main body rubber elastic body 16. In the blast treatment, the blast material (abrasive) is sprayed to the surface of the intermediate sleeve 18 to peel and roughen the coating film on the surface of the intermediate sleeve 18, thereby improving the adhesive strength of the main body rubber elastic body 16.

In the blast treatment, a large number of intermediate sleeves 18 may be treated at once. For example, the blast treatment equipment is provided with a drum (treatment container) capable of accommodating a large number of intermediate sleeves 18, and by rotating the drum and moving a large number of intermediate sleeves 18 in the drum while spraying blast material on the intermediate sleeves 18, it is possible to apply blast treatment to a large number of the intermediate sleeves 18 at once.

However, for example, in an intermediate sleeve with conventional structure with a slit extending linearly in the axial direction, when applying blast treatment to a large number of intermediate sleeves at once as described above, there are cases where the other intermediate sleeve 18 enters the slit of the intermediate sleeve and is held in an overlapped state, and the blast treatment may not reach the overlapped part. As a result, there is a risk that the adhesive strength of the main body rubber elastic body 16 to the intermediate sleeve may vary, or that the main body rubber elastic body 16 may partially peel off from the intermediate sleeve.

Thus, the intermediate sleeve 18 of the embodiment has a structure in which the slit 22 includes the straight parts 24, 24 that do not directly overlap in axial view. As a result, even if the other intermediate sleeve 18 (cylindrical part 20) enters the slit 22 of the intermediate sleeve 18, the other intermediate sleeve 18 does not continuously enter over both the straight parts 24, 24, and the other intermediate sleeve 18 is easily removed and separated from the slit 22. Thus, by preventing overlap caused by the entering of the other intermediate sleeve 18 into the slit 22 of the intermediate sleeve 18 from being held and allowing the blast treatment to cover the entire intermediate sleeve 18, the adhesion of the main body rubber elastic body 16 to the intermediate sleeve 18 can be stabilized by stable pretreatment of the intermediate sleeve 18.

Further, even if the entering of the other intermediate sleeve 18 in the slit 22 of the intermediate sleeve 18 is held, the other intermediate sleeve 18 is allowed to enter only one straight part 24 of the slit 22, and does not enter over both the straight parts 24, 24. Thus, compared to a conventionally constructed intermediate sleeve in which the other intermediate sleeve may enter across the entire slit, an overlap area of the intermediate sleeves 18, 18 is decreased, and a region where the blast treatment does not reach is narrowed, thereby reducing variations in adhesive strength. Moreover, in order to facilitate understanding, the intermediate sleeve 18 and the other intermediate sleeve 18 have been described separately, but the intermediate sleeve 18 and the other intermediate sleeve 18 described above are substantially the same as each other and have the structure according to the embodiment.

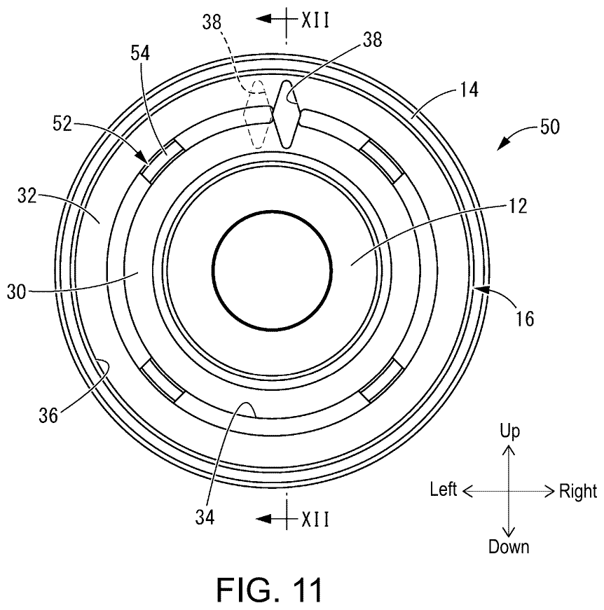

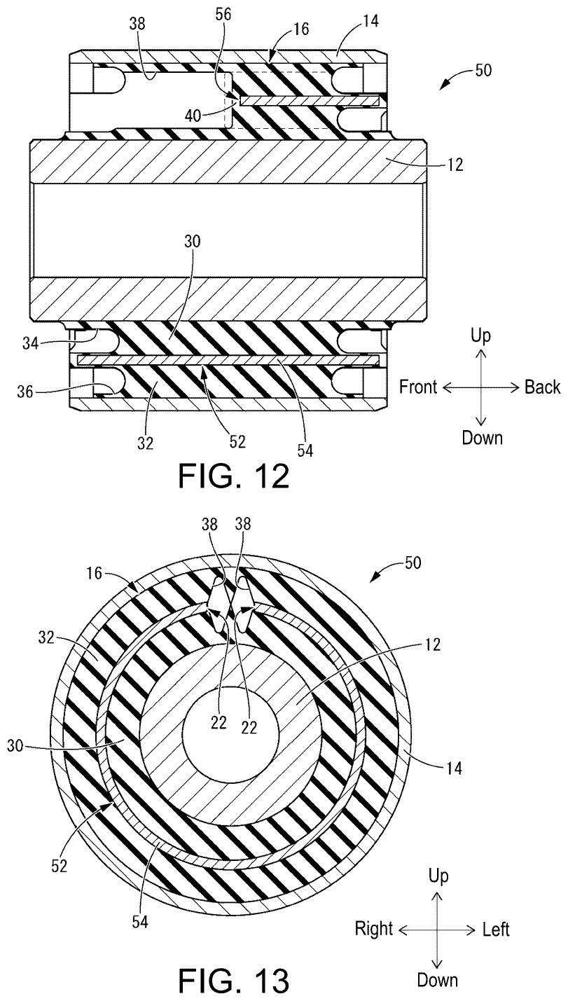

In FIGS. 11 to 13, a cylindrical vibration isolator 50 as a second embodiment of the disclosure is shown in a state before the outer cylindrical member 14 is reduced in diameter. The cylindrical vibration isolator 50 includes an intermediate sleeve 52. In the following description, members and parts that are substantially the same as those in the first embodiment may be given the same reference numerals as in the first embodiment, and the description thereof may be omitted.

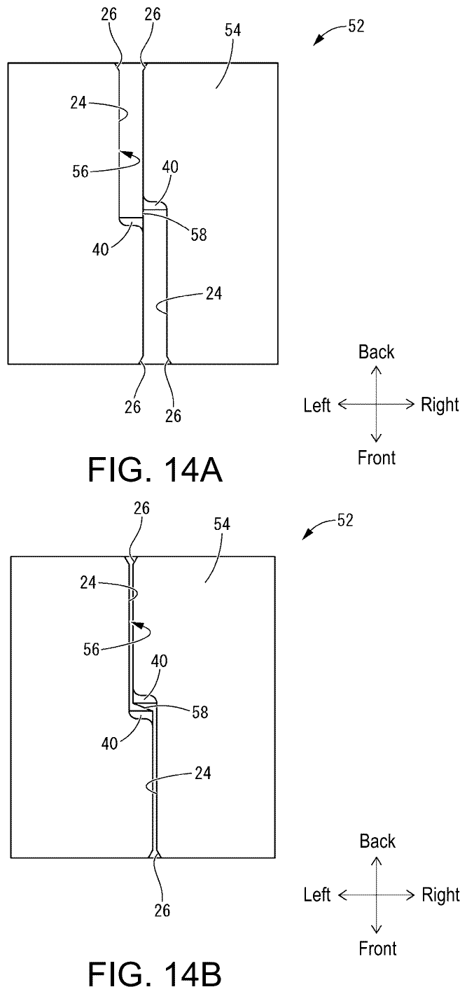

The intermediate sleeve 52 includes a cylindrical part 54 that has a substantially cylindrical shape as a whole. The cylindrical part 54 is divided in the circumferential direction by a slit 56 at a part in the circumferential direction. As shown in FIG. 14A, the slit 56 includes the straight parts 24, 24 that extend linearly in the axial direction from both axial ends of the cylindrical part 54. The straight parts 24, 24 of the embodiment are disposed at different positions in the circumferential direction of the cylindrical part 54, as in the first embodiment, but compared to the first embodiment, are spaced apart from each other in the circumferential direction and are closer to each other in the circumferential direction. As a result, the axially inner ends of the straight parts 24, 24 are directly connected without being connected via the intermediate part 28 extending in the circumferential direction as in the first embodiment.

The cavities 38, 38 are formed in parts of the main body rubber elastic body 16 corresponding to the straight parts 24, 24. Since the straight parts 24, 24 of the slit 56 are adjacent to each other in the circumferential direction, the cavities 38, 38 formed at positions corresponding to the respective straight parts 24 are adjacent to each other in the circumferential direction.

A thin film-like intermediate rubber 58 is formed between adjacent parts at the deep side of the cavities 38, 38. The intermediate rubber 58 is a rubber film formed in a gap between molds for forming the cavities 38, 38 during molding of the main body rubber elastic body 16, and is integrally formed with the main body rubber elastic body 16. The intermediate rubber 58 of the embodiment is formed so as to mutually connect the deep wall rubbers 40, 40 formed at the deep side of the cavities 38, 38.

Moreover, by having the outer cylindrical member 14 reduced in diameter after the vulcanization-molding of the main body rubber elastic body 16, as shown in FIG. 14B, the intermediate sleeve 52 is deformed and reduced in diameter such that the circumferential width of the straight parts 24, 24 of the slit 56 decreases. When the diameter of the intermediate sleeve 52 is reduced, both axial ends of the intermediate rubber 58 are relatively displaced in the circumferential direction, causing shear deformation. The intermediate rubber 58 of the embodiment, which is in the form of a thin film, may be broken as it is deformed.

The same effects as in the first embodiment can also be obtained by the cylindrical vibration isolator 50 including such an intermediate sleeve 52. Further, in the cylindrical vibration isolator 50 of the embodiment, since a circumferential thickness of the intermediate rubber 58 is decreased, when the diameter of the intermediate sleeve 52 is reduced, the force resisting the diameter reduction based on the elasticity of the intermediate rubber 58 is further decreased, such that the intermediate sleeve 52 can be effectively deformed and reduced in diameter with a smaller force.

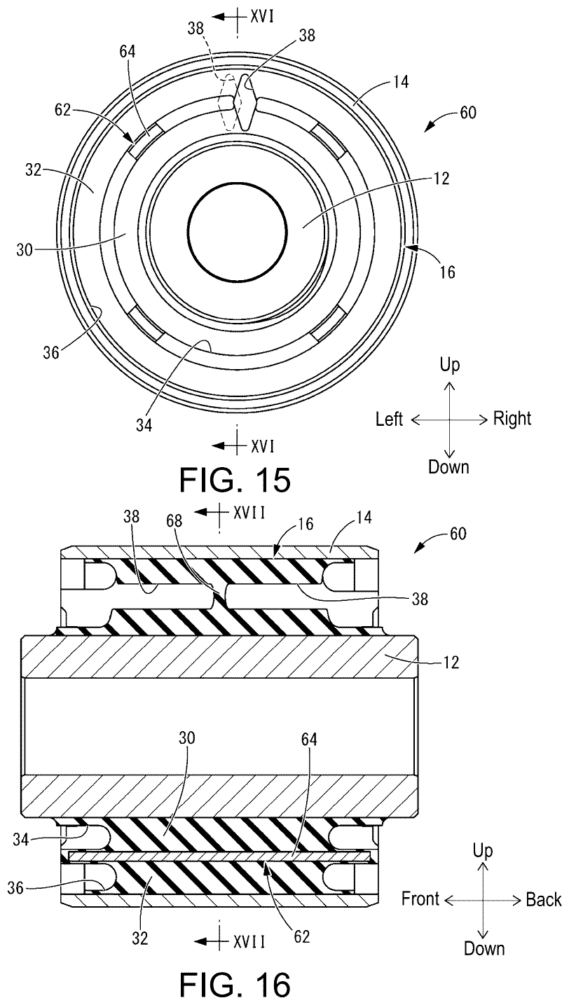

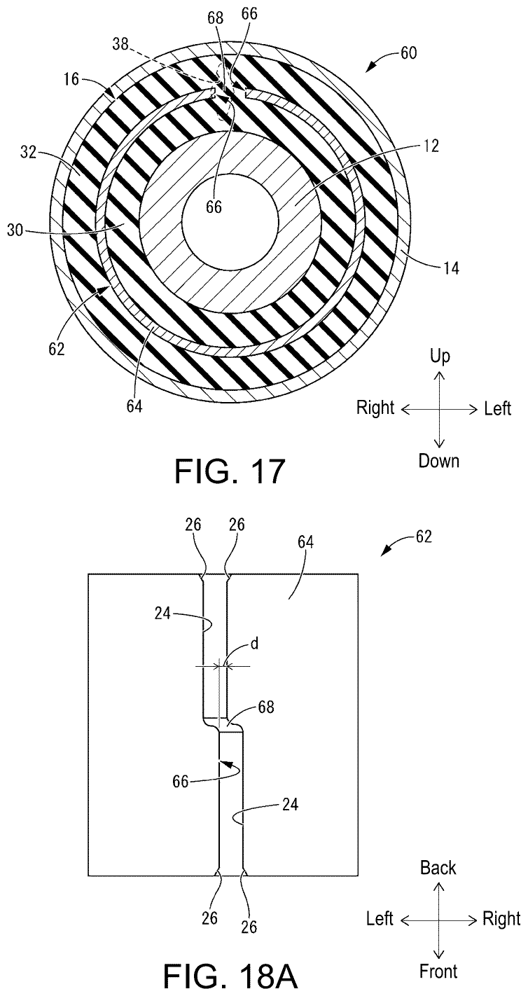

FIGS. 15 to 17 show a cylindrical vibration isolator 60 as a third embodiment of the disclosure in a state before the outer cylindrical member 14 is reduced in diameter. The cylindrical vibration isolator 60 includes an intermediate sleeve 62.

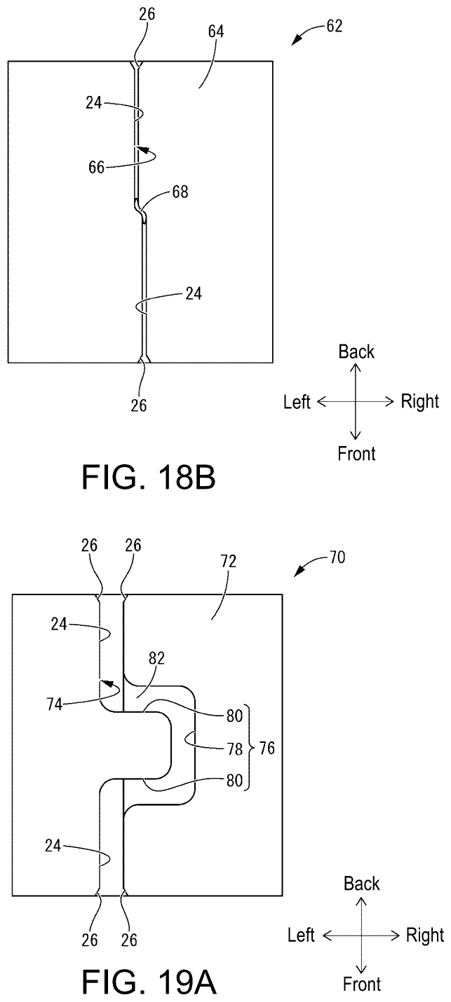

The intermediate sleeve 62 includes a cylindrical part 64 that has a substantially cylindrical shape as a whole. The cylindrical part 64 is divided in the circumferential direction by a slit 66 at a part in the circumferential direction. As shown in FIG. 18A, the slit 66 includes the straight parts 24, 24 that extend linearly in the axial direction from both axial ends of the cylindrical part 64. The straight parts 24, 24 of the embodiment are formed at different positions in the circumferential direction of the cylindrical part 64, but have a part overlapping directly in axial view, and the slit 66 extends linearly straight through the overlapped part in the axial direction. A circumferential width (overlap margin) d of the overlapped part of the straight parts 24, 24 in axial view is smaller than a radial thickness of the cylindrical part 64 of the intermediate sleeve 62. Thus, even if the cylindrical part 64 of the other intermediate sleeve 62 enters the slit 66 of the intermediate sleeve 62 from one straight part 24 side, the other intermediate sleeve 62 is prevented from entering beyond a connection part of the straight parts 24, 24 to the other straight part 24.

An intermediate rubber 68 is formed at the connection part of the straight parts 24, 24. The intermediate rubber 68 of the embodiment is located at a deep side of each of the straight parts 24, 24, and mutually connects inner surfaces of the walls on both circumferential sides of the slit 66 at the connection part of the straight parts 24, 24 in the circumferential direction.

Moreover, by having the outer cylindrical member 14 reduced in diameter after the vulcanization-molding of the main body rubber elastic body 16, as shown in FIG. 18B, the intermediate sleeve 62 is deformed and reduced in diameter such that the circumferential width of the straight parts 24, 24 of the slit 66 decreases. When the diameter of the intermediate sleeve 62 is reduced, the intermediate rubber 68 is compressed and deformed in the circumferential direction, but since an axial length of the intermediate rubber 68 is made sufficiently small, the resistance force by the compression spring of the intermediate rubber 68 is unlikely to be a problem when the diameter of the intermediate sleeve 62 is reduced.

The same effects as in the first embodiment can also be obtained by the cylindrical vibration isolator 60 including such an intermediate sleeve 62. As shown in the embodiment, the straight parts 24, 24 of the slit 66 need not necessarily be disposed at positions separated in the circumferential direction, and even if they partially overlap in axial view, the same method can be adopted as long as the overlap margin is specified so as to restrict the other intermediate sleeve s 62 from entering the slit.

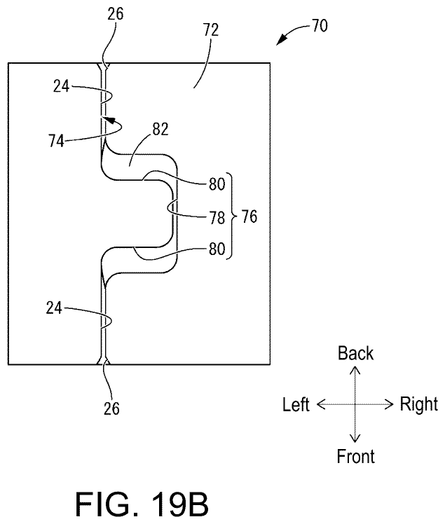

FIG. 19 shows an intermediate sleeve 70 constituting a cylindrical vibration isolator according to a fourth embodiment of the disclosure. In the embodiment, only the intermediate sleeve 70 and an intermediate rubber 82 to be described later are shown, but other parts of the cylindrical vibration isolator (not shown) may have the same structure as the first embodiment.

The intermediate sleeve 70 includes a cylindrical part 72 that has a substantially cylindrical shape as a whole. The cylindrical part 72 is divided in the circumferential direction by a slit 74 at a part in the circumferential direction. As shown in FIG. 19A, the slit 74 includes the straight parts 24, 24 that extend linearly in the axial direction from both axial ends of the cylindrical part 72. The straight parts 24, 24 of the embodiment are formed at the same position in the circumferential direction of the intermediate sleeve 70.

The slit 74 includes an intermediate part 76 that mutually connects the straight parts 24, 24. The intermediate part 76 includes an axial extension part 78 extending axially at a position different in the circumferential direction from the straight parts 24, 24, and circumferential extension parts 80, 80 connecting the deep ends of the straight parts 24, 24 with both ends of the axial extension part 78. As shown in FIG. 19A, the intermediate part 76 has a transverse U-shape in plan view, and both ends are connected to the straight parts 24 respectively.

The intermediate rubber 82 is fixed to the intermediate part 76 of the slit 74. The intermediate rubber 82 is integrally formed with the main body rubber elastic body 16, not shown, and is provided over the entire intermediate part 76.

Moreover, by having the outer cylindrical member 14 reduced in diameter after the vulcanization-molding of the main body rubber elastic body 16, as shown in FIG. 19B, the intermediate sleeve 70 is deformed and reduced in diameter such that the circumferential width of the straight parts 24, 24 of the slit 74 decreases. When the diameter of the intermediate sleeve 70 is reduced, the intermediate rubber 82 is compressed in the circumferential direction, but as long as an axial length of the intermediate rubber 82 is made sufficiently small, the resistance force by the compression spring of the intermediate rubber 82 can be prevented from becoming a problem when the diameter of the intermediate sleeve 70 is reduced. Further, an axial length of the axial extension part 78 may be made sufficiently small, for example, a width of the axial extension part 78 and/or a width of the circumferential extension part 80 may be set to be larger than the width of the straight part 24. Furthermore, an overall shape of the intermediate part 76 is not limited to the exemplified transverse U-shape in front view, but may be an arc shape or the like.

A cylindrical vibration isolator including such an intermediate sleeve 70 may also provide the same effects as the first embodiment. Like the slit 74 shown in the embodiment, the straight parts 24, 24 do not necessarily have to be provided at different positions in the circumferential direction, and as long as the other intermediate sleeve 70 is restricted from entering by the intermediate part 76, the same effects as in the embodiment described above can be achieved.

Although the embodiments of the disclosure have been described in detail above, the disclosure is not limited by the specific description. For example, the width of the straight part 24 of the slit 22 may vary in the axial direction. Specifically, for example, the width of the straight part 24 may gradually increase toward both axial ends.

The intermediate part 28 connecting the straight parts 24, 24 in the slit 22 may extend in the circumferential direction while being inclined in the axial direction, or an inclination angle may change in the circumferential direction.

An opening shape of the cavity 38 formed in the main body rubber elastic body 16 is not limited to the substantially rhombic shape shown in the above embodiment, but may be substantially circular, including an ellipse, or substantially rectangular.

The intermediate rubber formed within the slit is not essential and may not need to be formed. Moreover, when the intermediate rubber is formed, it is desirable that the intermediate rubber is provided such that it is shear-deformed when the intermediate sleeve is deformed and reduced in diameter, but as shown in the third and fourth embodiments, the intermediate rubber may have a part that is compressed or may be compressed as a whole when the intermediate sleeve is deformed and reduced in diameter.

In the above embodiments, the blast treatment has been exemplified as a treatment in which the other intermediate sleeve may enter the slit of the intermediate sleeve, but for example, the other intermediate sleeve may also be prevented from entering the slit of the intermediate sleeve in the case of treatment of the intermediate sleeve other than blast treatment such as spraying with adhesive.

What is claimed is:

1. A cylindrical vibration isolator in which an inner shaft member and an outer cylindrical member are connected by a main body rubber elastic body, and a cylindrical intermediate sleeve that extends in a circumferential direction between the inner shaft member and the outer cylindrical member in a radial direction is fixed to the main body rubber elastic body,
wherein in a part of the intermediate sleeve in the circumferential direction, a slit penetrating axially is formed,
both end parts of the slit are straight parts extending axially, and
a direct overlap margin of the straight parts on both sides in axial view is smaller than a radial thickness of the intermediate sleeve.

2. The cylindrical vibration isolator according to claim 1,
wherein the straight parts on both sides of the slit are formed at different positions in the circumferential direction of the intermediate sleeve, and
the slit comprises an intermediate part that mutually connects the straight parts on both sides in the circumferential direction.

3. The cylindrical vibration isolator according to claim 2,
wherein in the intermediate part of the slit, an intermediate rubber that mutually connects both axial side parts of the intermediate sleeve with respect to the intermediate part is provided.

4. An intermediate sleeve for cylindrical vibration isolator, comprising a cylindrical part extending in a circumferential direction between an inner shaft member and an outer cylindrical member in a radial direction, the cylindrical part being connected to the inner shaft member and the outer cylindrical member by a main body rubber elastic body,
wherein in a part of the cylindrical part in the circumferential direction, a slit penetrating axially is formed,
both end parts of the slit are straight parts extending axially, and
a direct overlap margin of the straight parts on both sides in axial view is smaller than a radial thickness of the cylindrical part.
